(19) United States
(12) Patent Application Publication
(10) Pub. No.: US 2008/0083818 A1
(43) Pub. Date: Apr. 10, 2008

(54) Measuring the bonding of bonded substrates

(75) Inventors: Keith Frank Best, Best (NL); Cheng-Qun Gui, Best (NL); Budiman Sutedja, Venlo (NL); Wilhelmus Johannes Maria De Laat, Heeswijk-Dinther (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/544,000

(22) Filed: Oct. 6, 2006

(51) Int. Cl. B23K 31/00

(52) U.S. Cl. 228/103

(57) ABSTRACT

A method of measuring bonding quality of a bonded substrate having an upper substrate on top of a lower substrate, the method comprising etching one or more windows in the upper substrate such that overlay measurement alignment marks on the upper substrate may be seen by a measurement system and overlay measurement alignment marks on the lower substrate may be seen by the measurement system, using the measurement system to measure the positions of the overlay measurement alignment marks, determining the distance between corresponding overlay measurement alignment marks on the upper and lower substrates, and adjusting the determined distance to take into account an offset between the overlay measurement alignment marks on the upper substrate and the overlay measurement alignment marks on the lower substrate.

### BACKGROUND OF THE INVENTION

1. Field of the Invention

The present invention relates to measuring the bonding of bonded substrates.

2. Description of the Related Art

In a lithographic manufacturing process, a lithographic apparatus applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at one time, and scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

In the manufacture of Micro Electronic Mechanical Systems (MEMS), a substrate including mechanical devices, here referred to as an upper substrate, is bonded on top of a substrate including electronic devices, referred to as a lower substrate. Both the lower as well as the upper substrate may be Silicon On Insulator (SOI) substrates. Currently, SOI substrate bonding technology is used at the manufacture of those substrates. Either qualitative infrared (IR) systems, double sided optical microscopes or surface flatness systems are used to assess the substrate bonding quality in order to test for de-lamination and alignment accuracy. Both of these methods are expensive, and in most cases they are qualitative rather than quantitative.

### SUMMARY OF THE INVENTION

It is desirable to provide a novel measurement of the bonding of bonded substrates.

According to a first aspect of the present invention there is provided a method of measuring bonding quality of a bonded substrate having an upper substrate on top of a lower substrate, the method comprising etching one or more windows in the upper substrate such that overlay measurement alignment marks on the upper substrate may be seen by a measurement system, and overlay measurement alignment marks on the lower substrate may be seen by the measurement system, using the measurement system to measure the positions of the overlay measurement alignment marks, determining the distance between corresponding overlay measurement alignment marks on the upper and lower substrates, and adjusting the determined distance to take into account an offset between the overlay measurement alignment marks on the upper substrate and the overlay measurement alignment marks on the lower substrate.

According to a second aspect of the invention there is provided a method of measuring bonding quality of a bonded substrate having an upper substrate on top of a lower substrate, the method comprising reducing the thickness of the upper substrate such that overlay measurement alignment marks on the upper substrate may be seen by a measurement system and overlay measurement alignment marks on the lower substrate may be seen by the measurement system, using the measurement system to measure the positions of the overlay measurement alignment marks, determining the distance between corresponding overlay measurement alignment marks on the upper and lower substrates, and adjusting the determined distance to take into account an offset between the overlay measurement alignment marks on the upper substrate and the overlay measurement alignment marks on the lower substrate.

According to a third aspect of the invention there is provided a bonded substrate comprising an upper substrate on top of a lower substrate, the upper and lower substrates being provided with a plurality of overlay measurement alignment marks, the overlay measurement alignment marks on the upper substrate being mirror images of the overlay measurement alignment marks on the lower substrate, an offset being provided between the overlay measurement alignment marks on the upper substrate and the overlay measurement alignment marks on the lower substrate.

### BRIEF DESCRIPTION OF THE DRAWINGS

Embodiments of the present invention will now be described, by way of example only, with reference to the accompanying schematic drawings in which corresponding reference symbols indicate corresponding parts, and in which:

FIG. 1 depicts a lithographic apparatus according to an embodiment of the present invention that can be used to expose substrates, e.g., bonded substrates;

FIG. 2 depicts an example of cross sections of a lower and an upper substrate according to one embodiment of the present invention;

FIG. 3 is a view from above of the lower substrate depicted in FIG. 2 before bonding;

FIGS. 4 to 6 are cross sections which illustrate exemplary bonding and subsequent etching steps involved in a method according to one embodiment of the present invention; and

FIG. 7 is a view from above of an alternative substrate which may be used.

### DETAILED DESCRIPTION

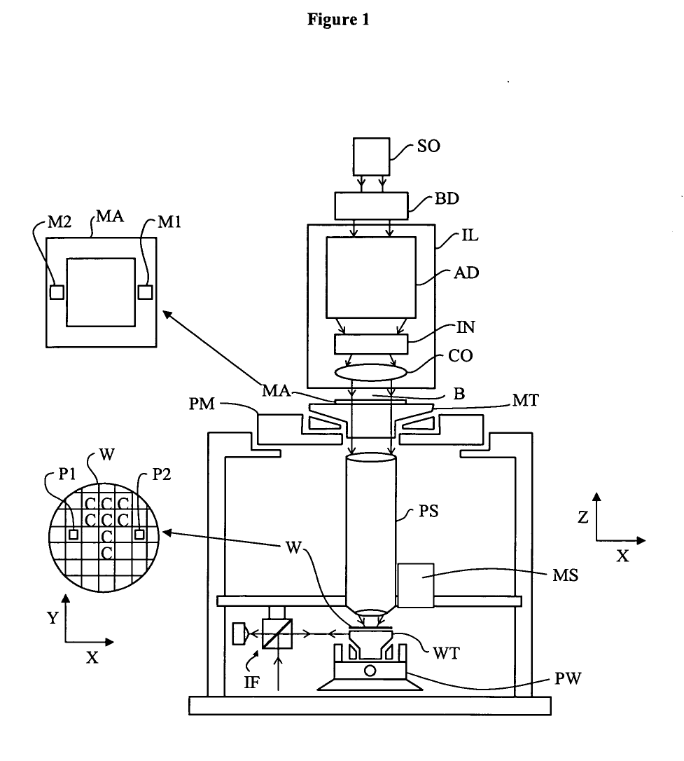

FIG. 1 schematically depicts a lithographic apparatus as can be used to expose substrates, e.g., bonded substrates. The apparatus includes an illumination system (illuminator) IL configured to condition a radiation beam B (e.g. UV radiation). A support (e.g. a mask table) MT is configured to support a patterning device (e.g. a mask) MA and is connected to a first positioning device PM configured to accurately position the patterning device in accordance with certain parameters. A substrate table (e.g. a wafer table) WT is configured to hold a substrate (e.g. a resist-coated wafer) W and is connected to a second positioning device PW configured to accurately position the substrate in accordance with certain parameters. A projection system (e.g. a refractive projection lens system) PS is configured to project the radiation beam B patterned by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, and/or control radiation.

The support supports, e.g. bears the weight of, the patterning device. It holds the patterning device in a manner that depends on the orientation of the patterning device, the design of the lithographic apparatus, and other conditions, for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located, for example, between the projection system and the substrate during exposure.

Referring to FIG. 1, the illuminator IL receives radiation from a radiation source SO. The source and the lithographic apparatus may be separate entities, for example when the source is an excimer laser. In such cases, the source is not considered to form part of the lithographic apparatus and the radiation is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjusting device AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support (e.g., mask table MT), and is patterned by the patterning device. Having traversed the mask MA, the radiation beam B passes through the projection system PS, which projects the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1 but may be an interferometric device, linear encoder or capacitive sensor) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed

In the manufacture of Micro Electronic Mechanical Systems (MEMS), a substrate including mechanical devices, here referred to as an upper substrate, is bonded on top of a substrate including electronic devices, referred to as a lower substrate. The accuracy with which the upper and lower substrates are aligned together is an important parameter.

In a typical substrate bonding apparatus, two substrates are arranged such that they face one another, typically one substrate being over the other. The substrates are positioned to a high precision using, for example, cameras which look at alignment marks on the substrates. The substrates are then moved towards one another until their surfaces come into contact such that they bond together. The bonding apparatus is designed such that bringing the substrates together involves movement in the z-direction only (where z is a direction perpendicular to the planes of the substrate). However, in some instances there may be a small amount of movement in the x and/or y-directions, such that the substrates may have been translated relative to one another before they come into contact. This may lead to the substrates being bonded together with an unacceptably poor accuracy, for example, an accuracy which is so poor that operation of the eventual MEMS devices is not possible or is compromised.

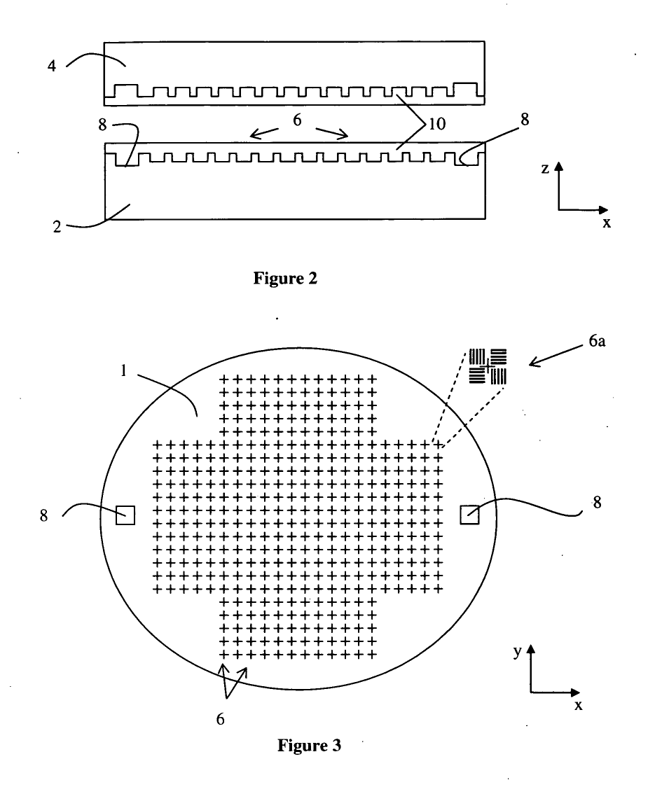

A user may wish to determine the accuracy of bonding provided by a particular bonding apparatus, so that he/she may have some confidence that MEMS devices made using the bonding apparatus will function correctly. An embodiment of the invention provides a measurement of the accuracy with which two substrates are bonded together by a bonding apparatus. The embodiment uses two substrates, illustrated in FIGS. 2 and 3.

Referring first to FIG. 2, a first substrate 2 and a second substrate 4 are shown in cross section. The first substrate 2 is located beneath the second substrate 4, and is referred to as the lower substrate. The second substrate 4 is referred to as the upper substrate. The substrates 2,4 are made from silicon. An array of alignment marks 6 is etched into each substrate 2. A layer of Low Temperature Oxide (LTO) 10 is provided on each of the substrates, the layer being typically around 1-2 microns thick. The LTO layers 10 are polished flat in order to improve bonding performance. Following polishing the LTO layers 10 may be as little as 0.5 microns thick. Insulators other than LTO may be used to provide the layers 10.

FIG. 3 shows the lower substrate 2 as viewed from above. It can be seen that a large proportion of the surface of the lower substrate 2 is covered with alignment marks 6, which are represented schematically as crosses. The alignment marks may, for example, be of the type shown schematically as 6a. This is a standard alignment mark which is often used in the lithography industry, and comprises two pairs of diffraction gratings disposed around a cross. Although it is not shown in FIG. 3, the cross may comprise an outline of a cross within which a further cross is provided. Typically, the pitch of diffraction gratings is around 8 microns. In some instances, the pitches of the alignment gratings may be slightly different from one another (for a given diffraction grating orientation), in order to allow interference effects to be used to increase the effective range of the alignment mark.

The alignment marks 6 will hereafter be referred to as overlay measurement alignment marks.

Also provided on the lower substrate 2 are two alignment marks 8, which are set apart from the other alignment marks 6. These alignment marks 8 are used to align the substrates 1, 2 during bonding, and will hereafter be referred to as bonding alignment marks. Although the bonding alignment marks 8 are represented as boxes, they may also be of the type shown schematically as 6a.

The upper substrate 4 is provided with alignment marks 6, 8 in the same general configuration as the lower substrate 2. The overlay measurement alignment marks 6 on the upper substrate 4 are, however, offset with respect to the overlay measurement alignment marks on the lower substrate 2. The offset may be, for example, around 640 microns, and may be, for example, in the Y-direction (it will be appreciated that other offset sizes and directions may be used). In addition to being offset, each of the overlay measurement alignment marks 6 on the upper substrate 4 is reversed (mirrored around the x-axis). This means that the overlay measurement alignment marks 6 are mirror images of the overlay measurement alignment marks provided on the lower substrate. This is done so that when the overlay measurement alignment marks 6 on the upper substrate 4 are viewed from above, they have the same appearance as the overlay measurement alignment marks on the lower substrate 2.

In a method which embodies the invention, the lower substrate 2 is located beneath the upper substrate 4 in a substrate bonding apparatus (i.e. as shown schematically in FIG. 2). The bonding alignment marks 8 are used by the bonding apparatus in order to align the substrates 2,4 with one another. Unlike the overlay measurement alignment marks 6, the bonding alignment marks 8 are not offset relative to each other. Instead, they have the same position on each substrate. Thus, by aligning the bonding alignment marks 8 with one another when the substrates are in the position shown in FIG. 2, the substrates are aligned relative to one another. As previously mentioned, the bonding alignment marks 8 may have the same form as the overlay measurement alignment marks 6 (shown with more detail as 6a). The cross at the centre of each bonding alignment mark 8 may be used to align the substrates.

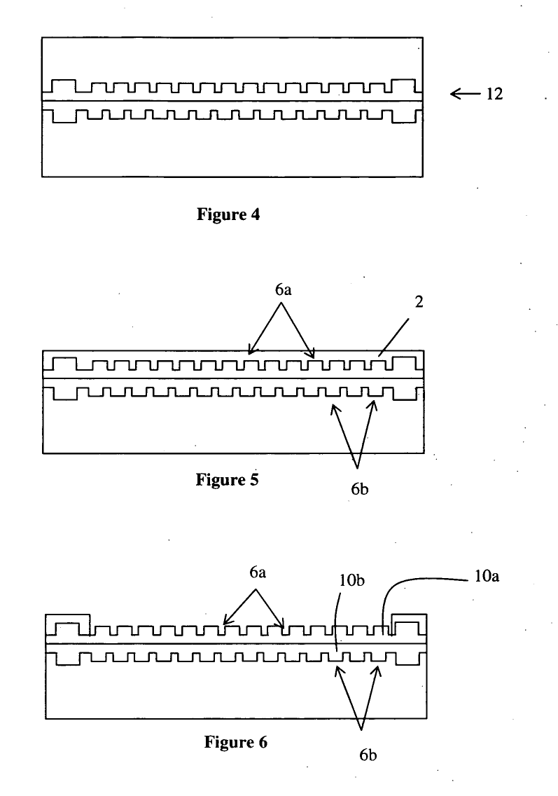

Once the substrates 2,4 have been aligned, they are brought together by the bonding apparatus so that they come into contact with one another, to form a bonded structure 12, shown schematically in FIG. 4. The wafers may be bonded either by heat, compression, electrical charge, or glue. In most bonding applications so called “Anodic bonding” is used, in which Van de Waals forces hold the substrates together.

Since substrate bonding apparatus are well known to those skilled in the art, no illustration of substrate bonding apparatus is necessary. A suitable substrate bonding apparatus which may be used to bond the substrates together is the SUSS substrate bonder made by SUSS MicroTec of Munich, Germany. The embodiment of the invention relates to measuring the overlay performance of the substrate bonding apparatus rather than the substrate bonding apparatus itself.

One the substrates have been bonded together, the upper substrate 4 of the bonded structure 12 is ground down to a reduced thickness, as shown schematically in FIG. 5. Typically, the reduced thickness is less than 100 microns. It may, for example, be 50 microns, 10 microns, 5 microns, or as little as 2 microns (e.g. if a silicon on insulator substrate is used).

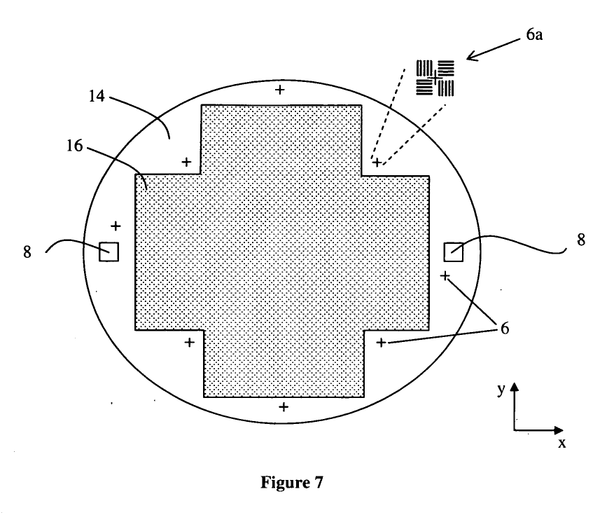

Windows are then etched over the overlay measurement alignment marks 6, to allow them to be viewed by a measurement system. This is shown schematically in FIG. 6. Since the upper substrate 4 is provided with a multiplicity of overlay measurement alignment marks 6 all arranged relatively close to one another, a single large window may be etched which exposes all of the overlay measurement alignment marks which are to be measured. The etching may be “end-pointing” on the LTO, i.e. the etching stops when it reaches the LTO. In this way, within the window, all of the silicon of the upper substrate 4 is removed. The result is an upper layer of LTO 10a.

The upper LTO layer 10a has an array of overlay measurement alignment marks 6 which were formed in it by the silicon, before the silicon was removed. The lower substrate 2, which has not been etched, retains an array of overlay measurement alignment marks 6. Thus, the bonded structure 12 includes a first set of overlay measurement alignment marks 6 provided in the silicon of the lower substrate 6b, and a set of overlay measurement alignment marks 6a imprinted in the upper layer of LTO 10a.

The bonded structure 12 is passed to a measurement apparatus, which may, for example, comprise a set of detectors arranged to detect the positions of diffraction fringes generated by the alignment marks, or may alternatively be some form of imaging detector. One suitable measurement system which may be used is described in European Patent Publication EP0906590, and comprises a so called ‘off-axis’ measurement system arranged to measure the positions of a plurality of orders of diffraction patterns generated by alignment marks. An alternative measurement system is described in European Patent Publication EP0963573, and comprises a so called ‘through the lens’ measurement system which measures the positions of alignment marks viewed through the projection system. Other measurement systems which may be used will be apparent to those skilled in the art.

The positions of the upper set of overlay measurement alignment marks 6 are measured using the measurement apparatus, and the positions of the lower set of overlay measurement alignment marks are also measured. The distance between the positions of the marks is calculated, and this is compared with the offset that was deliberately included when fabricating the upper and lower substrates 2,4. For example, as mentioned above, an offset of 640 microns may be included when making the substrates 2,4. If a distance of 660 microns is measured using the measurement apparatus, then this indicates that the bonding apparatus has an error in a particular direction of 20 microns. If the measured distance were 620 microns, then this would indicate that the bonding apparatus has an error of 20 microns in the opposite direction. The offset may be in one direction, for example in the Y-direction. Where this is the case, any distance between the overlay measurement alignment marks measured in the transverse direction (in this case the X-direction) indicates an error in the bonding apparatus.

The embodiment of the invention allows characterization of the bonding apparatus, by measuring the accuracy with which two substrates have been bonded together (referred to hereafter as the overlay accuracy). Typically, a given bonding apparatus will cause the same overlay error to arise each time a substrate is bonded. Therefore, calibration of this error allows the operation of the bonding apparatus to be modified to take account of the error (for example by introducing a corresponding offset in the opposite direction when aligning the substrates before they are brought together during bonding).

The measurement system may be provided in a dedicated piece of apparatus. Alternatively, the measurement system may be located within a lithographic apparatus. For example, the measurement system may be provided adjacent to the projection system PL, as represented schematically by box MS in FIG. 1.

In some instance, provided that the upper substrate 4 is ground down to a sufficiently shallow thickness, it may be possible to see the overlay measurement alignment marks 6 without needing to etch windows into the silicon of the upper substrate 4. For example, the ‘off-axis’ and ‘through the lens’ measurement systems described above may be capable of seeing an overlay measurement alignment marks through around 10 microns of silicon. Thus, if the upper substrate 4 is ground down to a thickness of 10 microns or less, then it may be possible to measure the positions of the overlay measurement alignment marks 6 without etching windows.

In the above description, a dedicated pair of substrates 2,4 are used to calibrate the error of a bonding apparatus. However, the embodiment of the invention also allows bonding overlay accuracy to be measured using substrates which are used to make MEMS devices. For example, referring to FIG. 7, a substrate 14 may be provided with functional features which will form MEMS devices, shown schematically here as shaded area 16. Overlay measurement alignment marks 6 may then be provided at suitable location, for example in areas of the substrate which are not provided with functional features 16. Bonding alignment marks 8 may also be provided.

A second substrate (not shown) having suitable functional features, bonding alignment marks 8, and offset and reversed overlay measurement alignment marks 6, may be bonded to the substrate. After bonding has taken place, one of the substrates may be ground down to a reduced thickness. Typically the reduced thickness is less than 100 microns. It could be as little as 2 to 4 microns, for example if a silicon on insulator substrate is used. If the substrate is sufficiently thin, for example less than 10 microns thick, then a measurement apparatus may be used to measure the overlay accuracy of the bonded structure. This may be done for example prior to lithographic projection of a pattern onto a bonded substrate. If the overlay accuracy is found to be less than a predetermined acceptable accuracy, then the bonded structure may be disposed of. This avoids incurring the expense of forming additional layers on the bonded structure only to find later that it does not work correctly.

The measurement apparatus may be a dedicated apparatus. Alternatively, the measurement apparatus may be provided within a lithographic apparatus. For example, the measurement system may be provided adjacent to the projection system PL, as represented schematically by box MS in FIG. 1. Where this is the case, the overlay accuracy of the bonding may be measured each time a bonded structure is introduced into the lithographic apparatus. The results of the measurement may be used to reject a substrate and/or may be retained in a memory or other storage device. This may provide useful statistical information about the bonding overlay. If some way of identifying each substrate is provided (for example via identification numbers or by keeping the substrates in a particular sequence), then information about the bonding overlay may be associated with specific substrates.

In the event that the ground down substrate is too thick to allow the measurement system to see the overlay measurement alignment marks, windows may be etched into the substrate as described above.

In the above description it has been mentioned that a measurement system may be used which is capable of seeing through, for example, 10 microns of silicon. It will be appreciated that this thickness is merely an example, and that other measurement systems may be used which are capable of seeing through more than 10 microns of silicon. For example, if the measurement system uses a laser to illuminate alignment marks, then a more powerful laser may be used to allow penetration of more silicon.

The measurement system may use radiation to illuminate the alignment marks. The radiation may be in any suitable spectrum. The radiation may be in the visible spectrum, for example 534 nanometers or 633 nanometers. Using radiation in the visible spectrum allows measurements with good accuracy to be obtained (e.g. better than 1 micron, better than 100 nanometers, or better than 10 nanometers). The radiation may be ultraviolet radiation. However, if the substrate is covered with a layer of photoresist, the ultraviolet radiation should be sufficiently long in wavelength that it does not cause the photoresist to be exposed.

The lower substrate 4 may be provided with alignment marks on its bottom surface. A suitable alignment system may be used to measure the positions of these marks, and use this information to determine the expected positions of the overlay measurement alignment marks 6. In order to do this, the alignment marks on the bottom surface of the substrate should have a know positional relationship with respect to the overlay measurement alignment marks provided on that substrate. One alignment system which could be used to measure the positions of the alignment marks on the bottom surface of the substrate and the overlay measurement alignment marks, is known as the Front to Backside Alignment System and is described in U.S. Pat. No. 6,768,539.

Where it is necessary to etch windows in the substrate in order to view the overlay measurement alignment marks, the number of windows that are etched can affect the overlay information that may be obtained. For example, five windows is enough to allow x and y translation, together with rotation, of the substrate to be measured. More windows will allow additional information to be obtained, for example, distortion of one of the substrates. Where windows are etched which include more than one overlay measurement alignment mark, it will be appreciated that less windows are required. Indeed, as described above in relation to FIG. 6, one large window may be used to view a multiplicity of overlay measurement alignment marks.

Although the above description has referred to alignment marks which comprise two pairs of diffraction gratings disposed around a cross, any suitable alignment marks may be used. Similarly, and suitable alignment mark measurement apparatus may be used.

Although specific reference may be made in this text to the use of lithographic apparatus in the manufacture of ICs, it should be appreciated that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. It should be appreciated that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the present invention in the context of optical lithography, it should be appreciated that the present invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the present invention have been described above, it will be appreciated that the present invention may be practiced otherwise than as described. For example, the present invention may take the form of a computer program containing one or more sequences of machine-readable instructions that are executable to instruct an apparatus to perform a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the present invention as described without departing from the scope of the claims set out below.

What is claimed is:

1. A method of measuring bonding quality of a bonded substrate having an upper substrate on top of a lower substrate, the method comprising:
etching one or more windows in the upper substrate such that overlay measurement alignment marks on the upper substrate may be seen by a measurement system and overlay measurement alignment marks on the lower substrate may be seen by the measurement system;
using the measurement system to measure the positions of the overlay measurement alignment marks;
determining the distance between corresponding overlay measurement alignment marks on the upper and lower substrates; and
adjusting the determined distance to take into account an offset between the overlay measurement alignment marks on the upper substrate and the overlay measurement alignment marks on the lower substrate.

2. The method of claim 1, wherein an insulator layer that acts as an endpoint to the etching is provided between the substrates, such that, within the one or more windows, the upper substrate is etched away to the insulating layer.

3. The method of claim 2, wherein the overlay measurement alignment marks of the upper substrate are formed in relief in the insulator layer.

4. The method of claim 1, wherein the measurement system uses radiation at a wavelength in the visible spectrum or the ultra-violet spectrum to measure the positions of the overlay measurement alignment marks.

5. The method of claim 1, wherein the overlay measurement alignment marks provided on the upper substrate are mirror images of the overlay measurement alignment marks provided on the lower substrate.

6. The method of claim 1, wherein the bonded substrate includes features which may be used to form MEMs devices.

7. The method of claim 1, wherein the offset is more than 100 microns.

8. The method of claim 1, wherein measurement of the positions of the overlay measurement alignment marks is performed within a lithographic apparatus.

9. A method of measuring bonding quality of a bonded substrate having an upper substrate on top of a lower substrate, the method comprising:
reducing the thickness of the upper substrate such that overlay measurement alignment marks on the upper substrate may be seen by a measurement system and overlay measurement alignment marks on the lower substrate may be seen by the measurement system;
using the measurement system to measure the positions of the overlay measurement alignment marks;
determining the distance between corresponding overlay measurement alignment marks on the upper and lower substrates; and
adjusting the determined distance to take into account an offset between the overlay measurement alignment marks on the upper substrate and the overlay measurement alignment marks on the lower substrate.

9. The method of claim 8, wherein the reduced thickness of the substrate is less than 50 microns.

10. The method of claim 9, wherein the reduced thickness of the substrate is less than 10 microns.

11. The method of claim 8, wherein the measurement system uses radiation at a wavelength in the visible spectrum or the ultra-violet spectrum to measure the positions of the overlay measurement alignment marks.

12. The method of claim 8, wherein the overlay measurement alignment marks provided on the upper substrate are mirror images of the overlay measurement alignment marks provided on the lower substrate.

13. The method of claim 8, wherein the bonded substrate include features which may be used to form MEMs devices.

14. The method of claim 8, wherein the offset is more than 100 microns.

15. The method of claim 8, wherein measurement of the positions of the overlay measurement alignment marks is performed within a lithographic apparatus.

16. A bonded substrate comprising an upper substrate on top of a lower substrate, the upper and lower substrates being provided with a plurality of overlay measurement alignment marks, the overlay measurement alignment marks on the upper substrate being mirror images of the overlay measurement alignment marks on the lower substrate, an offset being provided between the overlay measurement alignment marks on the upper substrate and the overlay measurement alignment marks on the lower substrate.

17. The bonded substrate of claim 16, wherein in addition to the overlay measurement alignment marks the substrate includes features which may be used to form MEMs devices.
